(19) United States
(12) Patent Application Publication
(10) Pub. No.: US 2007/0222093 A1
(43) Pub. Date: Sep. 27, 2007

(54) Production Method for Graded Index Type Optical Transmission Element

(76) Inventors: Takeshi Furuta, Tottori (JP); Masaaki Oda, Fukuoka (JP); Teruhiko Sugimori, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/578,995

(22) PCT Filed: Mar. 23, 2005
(86) PCT No.: PCT/JP05/05223

§ 371 Date: Oct. 19, 2006

(30) Foreign Application Priority Data
Apr. 22, 2004 (JP) 2004-126511

(51) Int. Cl. G02B 6/00

(52) U.S. Cl. 264/1.24

(57) ABSTRACT

A production method for an optical transmission element (1), wherein a cylindrical transparent resin is used as a core wire, a monomer becoming a polymer different in refractive index from the core wire after polymerized or a mixture of a monomer and a polymer (2) is bonded to the outer periphery of the core wire and the monomer is diffused from the outer periphery of the core wire to thereby form the monomer inside the core wire at a proper concentration distribution, and then the monomer is further polymerized to the core wire to provide a distribution layer having different refractive indexes from the center toward the outer periphery, whereby it is possible to provide a graded index type optical transmission element at low costs with a simple facility.

### TECHNICAL FIELD

The present invention relates to a production method for an optical transmission element that can usefully be used as various optical transmission passages in a light focusing optical fiber, a light focusing rod lens, a light sensor and the like, or as an image transmission array, more particularly an optical transmission element having a refractive index changing from a central portion toward an outer periphery in a cross section vertical to an optical transmission axis, that is, a so-called graded index type optical transmission element.

### BACKGROUND ART

An optical transmission element having a refractive index distribution continuously changing from its central portion toward its outer periphery in a cross section of the optical transmission element is known (for example, see JP-B-47-816 and JP-B-47-28059).

However, because the refractive index distribution type optical transmission element shown in JP-B-47-816 is prepared using a glass as a material with an ion exchange method, its productivity is low, and it is difficult to produce an element uniform in a lengthwise direction. That is, it is difficult to make elements have the identical shape (particularly, the identical length) and the identical performance. When it is attempted to have the identical performance, there is the difficulty that length of a refractive index distribution type optical transmission element is liable to be irregular, resulting in posing a problem on its handling.

The refractive index distribution type plastic optical transmission element shown in JP-B-47-28059 is prepared by that a mixture of at least two transparent polymers having different refractive indexes with each other and different solubility to a specific solvent is molded into a rod form or a fiber form, and the resulting molded product is dipped in the solvent to extract a part of the polymer from the surface of the molded product, thereby making that the mixing proportion of the polymer changes from the surface of the polymer molded product toward its central portion. Such a method can prepare at least a refractive index distribution type plastic rod-like lens. However, a product comprising a mixture of at least two polymers having different refractive indexes shows much fluctuation of a refractive index. As a result, light scattering is liable to occur with decreasing its transparency, and there is the problem that merit as the refractive index distribution type optical transmission element is not sufficient.

### DISCLOSURE OF INVENTION

### Problem to be Solved by the Invention

It is an object to produce a high precision graded index type optical transmission element having no fluctuation of refractive index and having a continuously changing refractive index distribution in high productivity with simple facilities in order to solve the above-mentioned problems in the prior art.

### Means for Solving the Problem

To achieve the above object, the invention provides a method for producing a graded index type optical transmission element having a layer having different refractive indexes from the center toward the outer periphery, wherein a cylindrical transparent resin is used as a core wire, a monomer having a refractive index after polymerization different from a refractive index of the core wire, or a mixture of the monomer and a polymer is adhered to an outer periphery of the core wire (adhering step), the resulting product in the adhering step (hereinafter referred to as an adhered product) is allowed to stand for a predetermined time to thereby diffuse the monomer inside the core wire from the outer periphery of the core wire toward the central portion thereof at an appropriate concentration distribution (diffusing step), and the monomer adhered and diffused is polymerized to cure (curing step).

An optical transmission element comprising n+2 layers including a central layer of the core wire and a layer directly adhered to the core wire may be formed by further adhering a monomer or a mixture of the monomer and a polymer to the optical transmission element obtained by the above method, allowing the resulting adhered product to stand for a predetermined time to thereby diffuse the monomer inside the core wire from the outer periphery of the optical transmission element toward the central portion thereof at an appropriate concentration distribution, polymerizing the monomer adhered and diffused to cure, and repeating the above steps one to n times.

Further, it is desirable to use the monomer or a mixture of the monomer and a polymer, corresponding to the respective layer such that the refractive index of the inner layer is higher than the refractive index of the outer layer. Moreover, it is desirable to use the monomer or a mixture of the monomer and a polymer such that each layer has a thickness of 100 μm or less,

Furthermore, in the adhering step, it is preferable to adhere the monomer or a mixture of the monomer and a polymer to the core wire at a free interfacial portion of a liquid level of the monomer or a mixture of the monomer and a polymer by passing the core wire so as to pull up the same in the monomer or a mixture of the monomer and a polymer from the lower side to the upper side.

Furthermore, in the adhering step, the monomer or a mixture of the monomer and a polymer can be adhered while rotating the same in horizontal direction. In the diffusing step, it is preferable that time of allowing the core wire to stand after the adhering step in order to diffuse the monomer is 60 seconds.

As the monomer, a radical polymerizable vinyl monomer and the like can be used. As the specific examples of the radical polymerizable vinyl monomer that can be used, methyl methacrylate (nD (refractive index)=1.49); styrene (nD=1.59); chlorostyrene (nD=1.61); vinyl acetate (nD=1.47); a fluorinated alkyl (meth)acrylate having nD=1.37 to 1.44, such as 2,2,3,3-tetrafluoropropyl(meth)acrylate, 2,2,3,3, 4,4,5,5-octafluoropropyl(meth)acrylate, 2,2,3,4,4,4-hexafluoropropyl(meth)acrylate, and 2,2,2-trifluoroethyl(meth)acrylate; (meth)acrylates having nD=1.43 to 1.62, such as ethyl(meth)acrylate, phenyl(meth)acrylate, benzyl(meth)acrylate, hydroxyalkyl(meth)acrylate, alkyleneglycol di(meth)acrylate, trimethylolpropane-di or tri(meth)acylate, pentaerythritol-di, tri or tetra(meth)acrylate, diglycerin tetra(meth)acrylate, and dipentaerythritol hexa(meth)acrylate; diethyleneglycol bisallylcarbonate; fluorinated alkyleneglycol poly(meth)acrylate; and the like can be exemplified. A mixed solution obtained by mixing two or more kinds of those monomers can be used.

It is preferable for the polymer to be soluble in the radical polymerizable vinyl monomer, and have good compatibility with the polymer formed. For example, a polymer of the radical polymerizable vinyl monomer, a copolymer in which at least two radical polymerizable vinyl monomers are copolymerized, a polymethyl methacrylate (nD=1.49), a polymethylmethacrylate copolymer (nD=1.47 to 1.50), a poly-4-methylpentene-1 (nD=1.46), an ethylene/vinyl acetate copolymer (nD=1.46 to 1.50), a polycarbonate (nD=1.50 to 1.57), a polyvinylidene fluoride (nD=1.42), a vinylidene fluoride/tetrafluoroethylene copolymer (nD=1.42 to 1.46), a vinylidene fluoride/tetrafluoroethylene/hexafluoropropene copolymer (nD=1.40 to 1.46), a polyfluoroalkyl(meth)acrylate polymer, and the like are exemplified.

To cure the uncured monomer, it is preferable to add a heat curing catalyst, a light curing catalyst, or a heat curing catalyst and a light curing catalyst, in the uncured product. As the heat curing catalyst, a peroxide catalyst is generally used. As the light curing catalyst, benzophenone, benzoin alkyl ether, 4′-isopropyl-2-hydroxy-2-methyl-propiophenone, 1-hydroxycydohexylphenyl ketone, benzylmethyl ketal, 2,2-diethoxyacetophenone, chlorothioxanthone, a thioxanthone compound, a benzophenone compound , ethyl 4-dimethylaminobenzoate, isoamyl 4-dimethlaminobenzoate , N-methyldiethanolamine, triethylamine and the like are exemplified.

To cure the uncured monomer, heat source such as ultraviolet rays, or an active light such as ultraviolet laser, ultraviolet LED, ultraviolet lamp or EL is acted from the circumference in the curing portion, thereby heat treating or light irradiation treating the monomer containing the heat curing catalyst or the light curing catalyst.

### ADVANTAGE OF THE INVENTION

The production method of an optical transmission element of the invention can produce a high precision graded index type optical transmission element having no fluctuation of refractive index, having a continuously changing refractive index distribution, and having a refractive index distribution uniform in a lengthwise direction with simple facilities by conducting molding at a free interface of a solution and forming a precise refractive index distribution by multilayer formation, as compared with the conventionally developed production method of the same kind of the optical transmission element.

### BRIEF DESCRIPTION OF DRAWINGS

FIG. 1 is a schematic view showing a structure of the production apparatus used in the production method of the graded index type optical transmission element according to the invention.

FIG. 2 is a schematic view showing the state that light snakes inside the optical transmission element.

FIG. 3 is a graph showing a refractive index distribution of the optical transmission element obtained in Example 1 according to the invention by a radius from the center and a refractive index at that position.

FIG. 4 is a graph showing a refractive index distribution of the optical transmission element obtained in Example 2 according to the invention by a radius from the center and a refractive index at that position.

FIG. 5 is a graph showing a refractive index distribution of the optical transmission element obtained in Example 3 according to the invention by a radius from the center and a refractive index at that position.

FIG. 6 is a graph showing a refractive index distribution of the optical transmission element obtained in Example 4 according to the invention by a radius from the center and a refractive index at that position.

FIG. 7 is a graph showing a refractive index distribution of the optical transmission element obtained in Comparative Example 1 according to the invention by a radius from the center and a refractive index at that position.

FIG. 8 is a graph showing a refractive index distribution of the optical transmission element obtained in Comparative Example 2 according to the invention by a radius from the center and a refractive index at that position.

### BEST MODE FOR CARRYING OUT THE INVENTION

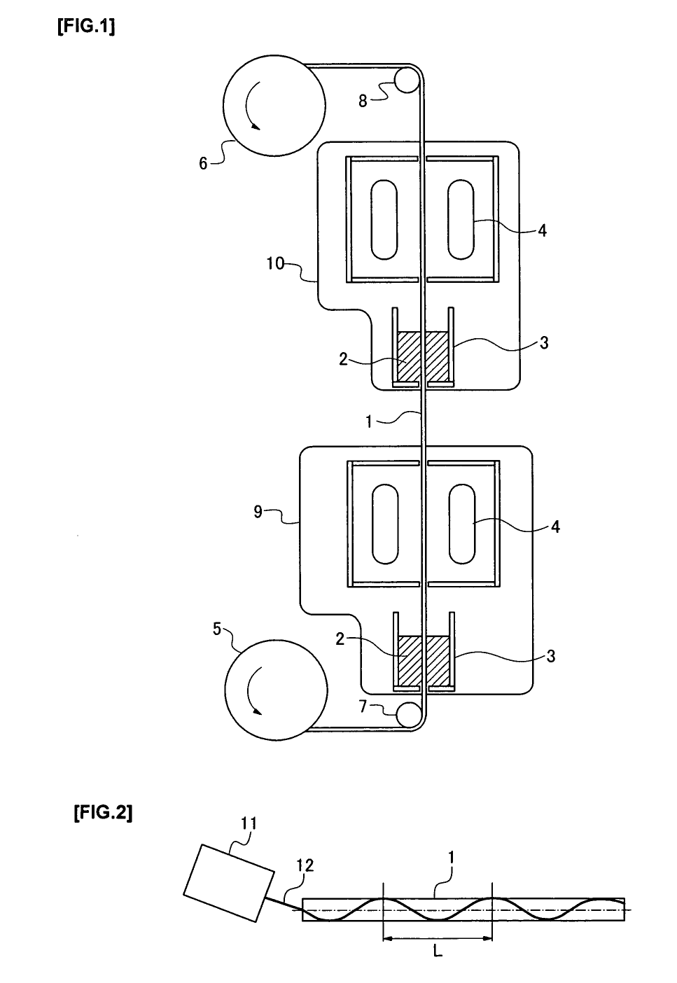

Production of the optical transmission element of the invention can be carried out using, for example, a shaping apparatus of FIG. 1. In the drawing, the reference numeral 1 shows an optical transmission element of the invention comprising a core wire made of a cylindrical transparent resin, and a monomer or a mixture of the monomer and a polymer, adhered to the outer periphery of the core wire and cured; the reference numeral 2 shows a monomer or a mixture of the monomer and a polymer; 3 shows a reservoir for placing a monomer or a mixture of the monomer and a polymer; the reference numeral 4 shows an ultraviolet lamp; the reference numeral 5 shows a delivery roller for sending a core wire; the reference numeral 6 shows an optical transmission element wind-up roller for winding up an optical transmission element; reference numerals 7 and 8 show a floating roller for guiding an optical transmission element; the reference numeral 9 shows first adhering, diffusing and curing steps of a monomer or a mixture of the monomer and a polymer; and the reference numeral 10 shows second adhering, diffusing and curing steps of a monomer or a mixture of the monomer and a polymer.

The core wire 1 made of a cylindrical transparent resin wound up by the core wire delivery roller 5 is wound by the optical transmission element wind-up roller 6 toward the upper side from the lower side. In the middle, the reservoir 3 containing a monomer or a mixture of the monomer and a polymer 2 is provided, and the monomer or the mixture of the monomer and the polymer 2 is adhered to the outer periphery of the core wire at a free interface in the upper liquid level of the monomer or the mixture of the monomer and the polymer 2.

After adhering the monomer or the mixture of the monomer and the polymer 2 to the outer periphery of the core wire, the monomer component therein permeates toward the center of the core wire in a given time until reaching the site irradiated with the ultraviolet lamp 4, and as a result, the concentration distribution of the monomer inside the core wire of the transparent resin becomes a certain concentration distribution according to the depth permeated. Further, the monomer diffuses from the monomer or the mixture of the monomer and the polymer 2 adhered to the outer periphery of the core wire to the core wire of the optical transmission element 1. As a result, the concentration of the monomer deceases even in the inside of the adhered layer composed of the monomer or a mixture of the monomer and a polymer according to the diffusion, and a certain concentration distribution according to the distance from the outer periphery of the core wire is formed. Thereafter, the monomer is cured by irradiating active light with the ultraviolet lamp 4.

In irradiating active light, it is preferable to conduct under an inert gas atmosphere such as nitrogen gas. By diffusing the monomer, an appropriate concentration distribution is formed in the central layer of the core wire and the adhered layer composed of the monomer or the mixture of the monomer and the polymer 2 adhered to the outer periphery of the core wire, and then the monomer is cured. Therefore, in the case that the refractive index of the monomer differs from the refractive indexes of the core wire and the polymer, an optical transmission element having a refractive index distribution continuously changing the refractive index from the central portion of the optical transmission element toward the outer periphery thereof is obtained.

Further, in the case that an optical transmission element comprising n+2 layers including a central layer of the core wire and a layer directly adhered to the core wire is formed by repeating the adhesion, diffusion and curing operations of the monomer or the mixture of the monomer and the polymer 2 to the outer periphery of the optical transmission element one to n times as shown in the reference numeral 10 in FIG. 1, the optical transmission element 1 having further large diameter and a refractive index distribution precisely controlled can be obtained. The third and thereafter adhering, diffusing and curing steps are not shown in the drawing, but are the same as the adhering, diffusing and curing steps of the reference numeral 9 and the reference numeral 10.

The monomer or the mixture of the monomer and the polymer 2 used in the second and thereafter operations comprises the radical polymerizable vinyl monomer, a polymer of the radical polymerizable vinyl monomer or a copolymer comprising at least two components of the radical polymerizable vinyl monomer being copolymerized, and a heat curing catalyst, a light curing catalyst, or a heat curing catalyst and a light curing catalyst.

Regarding the refractive index of the monomer or the mixture of the monomer and the polymer 2 to be adhered, diffused and cured to the periphery of the core wire, by being the refractive index of the polymer adhered to the inside higher than the refractive index of the polymer adhered to the outside, the optical transmission element 1 having a refractive index distribution such that the refractive index on the central axis of the optical transmission element is the highest, and the refractive index continuously decreases toward the outer periphery can be produced.

In the case of adhering, diffusing and curing the monomer or the mixture of the monomer and the polymer 2 to the outer periphery of the core wire, when it is adhered and cured such that thickness of each layer is 100 μm or less, and preferably 50 μm or less, uniformity of the film thickness adhered increases, and control of the refractive index distribution becomes more precise. In using as various optical transmission passages in a light focusing optical fiber, a light focusing rod lens, a light sensor and the like, or as an image transmission array, further preferable result can be obtained.

Further, in adhering the monomer or the mixture of the monomer and the polymer 2 to the outer periphery of the core wire, by rotating the monomer or the mixture of the monomer and the polymer 2 or the reservoir 3 for the monomer or the mixture of the monomer and the polymer in a horizontal direction, the monomer or the mixture of the monomer and the polymer 2 can further uniformly be adhered to the outer periphery of the core wire.

Measurement of the refractive index distribution in the Examples was conducted by the following method. In the case that a refractive index distribution is present inside the optical transmission element, incident light from the edge of the optical transmission element has the property to proceed while snaking inside of the optical transmission element as shown in FIG. 2. Therefore, helium neon laser light is entered inside the optical transmission element to observe a snaking state of light. Next, a refractive index distribution of the optical transmission element is measured using the commercially available interference microscope by the conventional method.

### EXAMPLE 1

80 parts by weight of methyl methacrylate (refractive index after polymerization nD=1.489), 20 parts by weight of benzyl methacrylate (refractive index after polymerization nD=1.568) and 0.5 part by weight of benzyl peroxide were placed in a plastic bottle, and polymerization was conducted at 80° C. for 1 hour, and at 95° C. for 2 hours. To complete the polymerization as possible, the resulting reaction mixture was aged at 120° C. for 4 hours. The aged mixture was vacuum dried at 80° C. for 24 hours, and residual monomer was removed. The polymer obtained was mechanically ground with a grinder. Molecular weight of the polymer was measured with GPC apparatus (HLC-8020), a product of Tosoh Corporation, and was found to be about 80,000. Further, refractive index of the polymer was measured with Abbe refractometer, and was found to be nD=1.544.

A vented deaeration single-screw extruder provided with a gear pump for quantitatively extruding the polymer at the tip thereof and capable of removing a volatile matter was used. An extrudate was wound up at a rate of 2 m per minute under the conditions that temperature at a screw portion of the extruder is 210° C., temperature at an extrusion nozzle portion having a diameter of 1 mm is 180° C., and discharge amount of the gear pump is 1 ml per minute. Thus, a cylindrical transparent resin having a diameter of 100 microns was obtained.

This cylindrical transparent resin was wound up on the core wire delivery roller 5 in the apparatus shown in FIG. 1. A mixture prepared by mixing and dissolving 32 parts by weight of polymethyl methacrylate VHK #0001, a product of Mitsubishi Rayon Co., Ltd., 68 parts by weight of a benzyl methacrylate monomer and 0.5 part by weight of 1-hydroxycyclohexylphenyl ketone was placed in the reservoir 3 in the first adhering, diffusing and curing steps 9 of the monomer or the mixture of the monomer and the polymer 2. The core wire was wound up by the optical transmission element wind-up roller 6 at a rate of 30 cm per minute.

The optical transmission element obtained had a diameter of 200 μm. Diameter unevenness over the length of 100 m of the optical transmission element was measured, and found to be 200 μm±5 μm. As the ultraviolet lamp at the middle, three high pressure mercury lamps were used. Distance of from a liquid level of a solution to the ultraviolet lamp was 30 cm, and time for diffusing the benzyl methacrylate monomer in the inside of the core wire was 60 seconds.

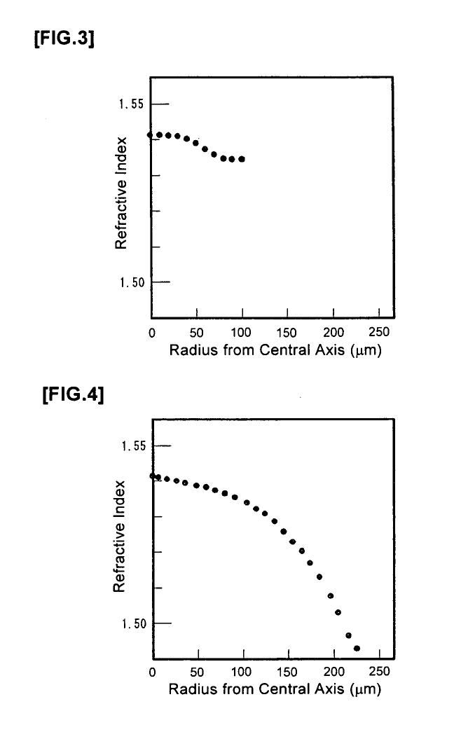

The edge face of the optical transmission element 1 obtained was polished at a right angle, and the laser light 12 was entered from the helium neon laser 11, as shown in FIG. 2. It could be confirmed that the laser light 12 proceeds in the optical transmission element 1 while snaking. Length L of the snaking cycle in this case was about 4.6 mm. Further, refractive index distribution of the optical transmission element was measured using an interference microscope. As a result, the optical transmission element had a refractive index distribution as shown in FIG. 3, and had the refractive index of the central portion nD=1.541 and the refractive index of the outermost periphery nD=1.535.

### EXAMPLE 2

A cylindrical transparent resin having a diameter of 100 microns obtained in the same manner as in Example 1 was used as a core wire. Similar to Example 1, a mixture prepared by mixing and dissolving 32 parts by weight of polymethyl methacrylate VHK #0001, a product of Mitsubishi Rayon Co., Ltd., 68 parts by weight of a benzyl methacrylate monomer and 0.5 part by weight of 1-hydroxycyclohexylphenyl ketone was placed in the reservoir 3, and used in the first adhering, diffusing and curing steps 9 of the mixture. A mixture prepared by mixing and dissolving 30 parts by weight of polymethyl methacrylate VHK #0001, a product of Mitsubishi Rayon Co., Ltd., 12 parts by weight of a methyl methacrylate monomer, 58 parts by weight of a benzyl methacrylate monomer and 0.5 part by weight of 1-hydroxycyclohexylphenyl ketone was placed in the reservoir 3, and used in the second adhering, diffusing and curing steps 10 of the mixture. Similar to Example 1, the core wire was wound up by the optical transmission element wind-up roller 6 at a rate of 30 cm per minute.

The optical transmission element obtained had a diameter of 200 μm after the first adhering, diffusing and curing steps 9, and 250 μm after the second adhering, diffusing and curing steps 10. Diameter unevenness over the length of 100 m of the optical transmission element was measured, and found to be 250 μm±5 μm. As the ultraviolet lamp at the middle, three high pressure mercury lamps were used. Distance of from a liquid level of each solution to the ultraviolet lamp was 30 cm, and time for diffusing the benzyl methacrylate monomer and methyl methacrylate monomer in the inside of the core wire or the optical transmission element was 60 seconds in both the first operation and the second operation.

The edge face of the optical transmission element obtained was polished at a right angle, and the laser light 12 was entered from the helium neon laser 11. It could be confirmed that the laser light 12 proceeds in the optical transmission element 1 while snaking. Length L of the snaking cycle in this case was about 5.9 mm.

Further, refractive index distribution of the optical transmission element was measured using an interference microscope. As a result, the optical transmission element had a refractive index distribution as shown in FIG. 4, and had a smooth distribution as compared with Example 1, and it was found to be the refractive index of the central portion nD=1.541 and the refractive index of the outermost periphery nD=1.527.

### EXAMPLE 3

A cylindrical transparent resin having a diameter of 100 microns obtained in the same manner as in Example 1 was used as a core wire. Similar to Example 1, a mixture prepared by mixing and dissolving 32 parts by weight of polymethyl methacrylate VHK #0001, a product of Mitsubishi Rayon Co., Ltd., 68 parts by weight of a benzyl methacrylate monomer and 0.5 part by weight of 1-hydroxycyclohexylphenyl ketone was placed in the reservoir 3, and used in the first adhering, diffusing and curing steps 9 of the mixture.

A mixture prepared by mixing and dissolving 30 parts by weight of polymethyl methacrylate VHK #0001, a product of Mitsubishi Rayon Co., Ltd., 7 parts by weight of a methyl methacrylate monomer, 63 parts by weight of a benzyl methacrylate monomer and 0.5 part by weight of 1-hydroxycyclohexylphenyl ketone was placed in the reservoir 3, and used in the second adhering, diffusing and curing steps 10 of the mixture.

A mixture prepared by mixing and dissolving 30 parts by weight of polymethyl methacrylate VHK #0001, a product of Mitsubishi Rayon Co., Ltd., 12 parts by weight of a methyl methacrylate monomer, 58 parts by weight of a benzyl methacrylate monomer and 0.5 part by weight of 1-hydroxycyclohexylphenyl ketone was placed in the reservoir 3, and used in the third adhering, diffusing and curing steps of the mixture. A mixture prepared by mixing and dissolving 30 parts by weight of polymethyl methacrylate VHK #0001, a product of Mitsubishi Rayon Co., Ltd., 22 parts by weight of a methyl methacrylate monomer, 48 parts by weight of a benzyl methacrylate monomer and 0.5 part by weight of 1-hydroxycyclohexylphenyl ketone was placed in the reservoir 3, and used in the fourth adhering, diffusing and curing steps of the mixture.

A mixture prepared by mixing and dissolving 30 parts by weight of polymethyl methacrylate VHK #0001, a product of Mitsubishi Rayon Co., Ltd., 37 parts by weight of a methyl methacrylate monomer, 33 parts by weight of a benzyl methacrylate monomer and 0.5 part by weight of 1-hydroxycyclohexylphenyl ketone was placed in the reservoir 3, and used in the fifth adhering, diffusing and curing steps of the mixture.

A mixture prepared by mixing and dissolving 28 parts by weight of polymethyl methacrylate VHK #0001, a product of Mitsubishi Rayon Co., Ltd., 54 parts by weight of a methyl methacrylate monomer, 18 parts by weight of a benzyl methacrylate monomer and 0.5 part by weight of 1-hydroxycyclohexylphenyl ketone was placed in the reservoir 3, and used in the sixth adhering, diffusing and curing steps of the mixture.

A mixture prepared by mixing and dissolving 27 parts by weight of polymethyl methacrylate VHK #0001, a product of Mitsubishi Rayon Co., Ltd., 73 parts by weight of a methyl methacrylate monomer and 0.5 part by weight of 1-hydroxycyclohexylphenyl ketone was placed in the reservoir 3, and used in the seventh adhering, diffusing and curing steps of the mixture. The core wire passed through each solution was wound up by the optical transmission element wind-up roller 6 at a rate of 30 cm per minute. The optical transmission element obtained had a diameter of 200 μm after the first adhering, diffusing and curing steps, 250 μm after the second adhering, diffusing and curing steps, 300 μm after the third adhering, diffusing and curing steps, 350 μm after the fourth adhering, diffusing and curing steps, 400 μm after the fifth adhering, diffusing and curing steps, 430 μm after the sixth adhering, diffusing and curing steps, and 450 μm after the seventh adhering, diffusing and curing steps.

Diameter unevenness over the length of 100 m of the optical transmission element was measured, and found to be 450 μm±20 μm. As the ultraviolet lamp at the middle, three high pressure mercury lamps were used. Distance of from a liquid level of each solution to the ultraviolet lamp was 30 cm, and time for diffusing the benzyl methacrylate monomer and methyl methacrylate monomer in the inside of the core wire or the optical transmission element was 60 seconds in the first to the seventh operations, respectively.

The edge face of the optical transmission element obtained was polished at a right angle, and the laser light 12 was entered from the helium neon laser 11. It could be confirmed that the laser light 12 proceeds in the optical transmission element 1 while snaking. Length L of the snaking cycle in this case was about 5.6 mm.

Further, refractive index distribution of the optical transmission element was measured using an interference microscope. As a result, the optical transmission element had a refractive index distribution as shown in FIG. 5, and had a smooth distribution as compared with Example 2, and it was found to be the refractive index of the central portion nD=1.541 and the refractive index of the outermost periphery nD=1.492.

### EXAMPLE 4

An optical transmission element was obtained in the same manner as in Example 3, except for rotating all reservoirs 3 in the first to seventh adhering steps. The optical transmission element obtained had a diameter of 200 μm after the first adhering, diffusing and curing steps, 250 μm after the second adhering, diffusing and curing steps, 300 μm after the third adhering, diffusing and curing steps, 350 μm after the fourth adhering, diffusing and curing steps, 400 μm after the fifth adhering, diffusing and curing steps, 430 μm after the sixth adhering, diffusing and curing steps, and 450 μm after the seventh adhering, diffusing and curing steps.

Diameter unevenness over the length of 100 m of the optical transmission element was measured, and found to be 450 μm ±10 μm. Thus, great improvement was observed in uniformity of adhesion. As the ultraviolet lamp at the middle, three high pressure mercury lamps were used. Distance of from a liquid level of each solution to the ultraviolet lamp was 30 cm, and time for diffusing the benzyl methacrylate monomer and methyl methacrylate monomer in the inside of the core wire or the optical transmission element was 60 seconds in the first to seventh operations, respectively.

The edge face of the optical transmission element obtained was polished at a right angle, and the laser light 12 was entered from the helium neon laser 11. It could be confirmed that the laser light 12 proceeds in the optical transmission element 1 while snaking. Length L of the snaking cycle in this case was about 5.6 mm.

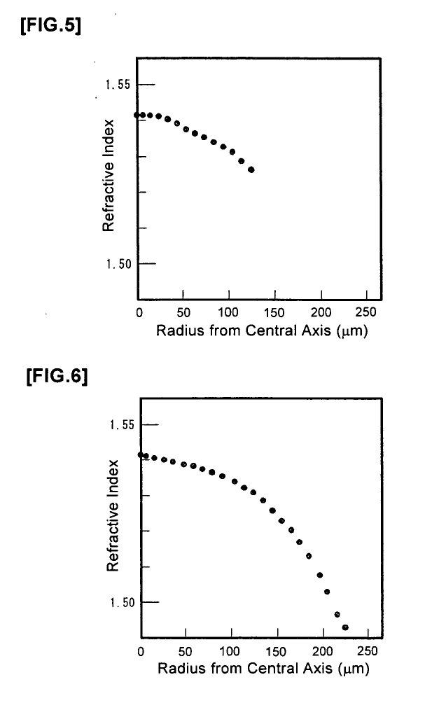

Further, refractive index distribution of the optical transmission element was measured using an interference microscope. As a result, the optical transmission element had a refractive index distribution as shown in FIG. 6, and had a smooth distribution as compared with Example 3, and it was found to be the refractive index of the central portion nD=1.541 and the refractive index of the outermost periphery nD=1.492.

### COMPARATIVE EXAMPLE 1

An optical transmission element was obtained in the same manner as in Example 2, except for using a mixture obtained by mixing and dissolving 45 parts by weight of polymethyl methacrylate VHK #0001, a product of Mitsubishi Rayon Co., Ltd., 55 parts by weight of a benzyl methacrylate monomer and 0.5 part by weight of 1-hydroxycyclohexylphenyl ketone in the first adhering, diffusing and curing steps of the mixture.

The optical transmission element obtained had a diameter of 550 μm after the first adhering, diffusing and curing steps, and 600 μm after the second adhering, diffusing and curing steps. Diameter unevenness over the length of 100 m of the optical transmission element was measured, and found to be 600 μm±150 μm. Thus, the element had large diameter unevenness, and could not be used as an optical transmission element. As the ultraviolet lamp at the middle, three high pressure mercury lamps were used. Distance of from a liquid level of each solution to the ultraviolet lamp was 30 cm, and time for diffusing the benzyl methacrylate monomer and methyl methacrylate monomer in the inside of the core wire or the optical transmission element was 60 seconds.

The edge face of the optical transmission element obtained was polished at a right angle, and the laser light 12 was entered from the helium neon laser 11. It could be confirmed that the laser light 12 proceeds in the optical transmission element 1 while snaking. Length L of the snaking cycle in this case was about 14.5 mm.

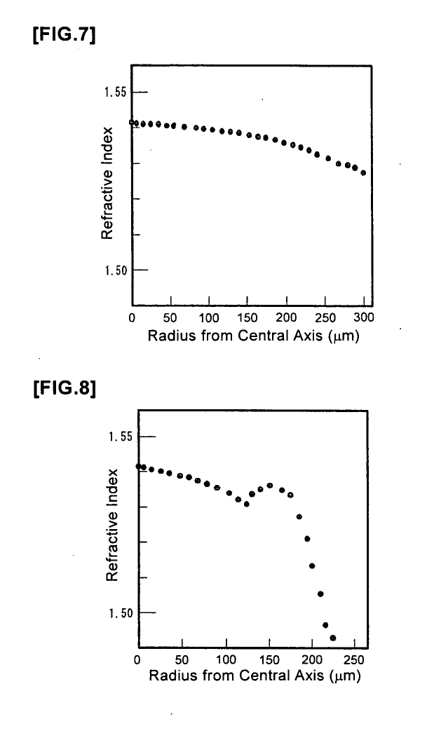

Further, refractive index distribution of the optical transmission element was measured using an interference microscope. As a result, the optical transmission element had a refractive index distribution as shown in FIG. 7. It was found to be the refractive index of the central portion nD=1.541 and the refractive index of the outermost periphery nD=1.527.

### COMPARATIVE EXAMPLE 2

An optical transmission element was obtained in the same manner as in Example 3, except for using a mixture obtained by mixing and dissolving 30 parts by weight of polymethyl methacrylate VHK #0001, a product of Mitsubishi Rayon Co., Ltd., 7 parts by weight of a methyl methacrylate monomer, 63 parts by weight of a benzyl methacrylate monomer and 0.5 part by weight of 1-hydroxycyclohexylphenyl ketone in the fourth adhering, diffusing and curing steps of the mixture.

The optical transmission element obtained had a diameter of 200 μm after the first adhering, diffusing and curing steps, 250 μm after the second adhering, diffusing and curing steps, 300 μm after the third adhering, diffusing and curing steps, 350 μm after the fourth adhering, diffusing and curing steps, 400 μm after the fifth adhering, diffusing and curing steps, 430 μm after the sixth adhering, diffusing and curing steps, and 450 μm after the seventh adhering, diffusing and curing steps.

Diameter unevenness over the length of 100 m of the optical transmission element was measured, and found to be 450 μm±10 μm. Thus, great improvement was observed in uniformity of adhesion. As the ultraviolet lamp at the middle, three high pressure mercury lamps were used. Distance of from a liquid level of each solution to the ultraviolet lamp was 30 cm, and time for diffusing the benzyl methacrylate monomer and methyl methacrylate monomer in the inside of the core wire or the optical transmission element was 60 seconds in the first operation and the second operation.

The edge face of the optical transmission element obtained was polished at a right angle, and the laser light was entered from the helium neon laser. The laser light is refracted outward at a position of about 300 μm from the center of the optical transmission element, and light began to leak to the outside of the optical transmission element. Therefore, this element could not be used as an optical transmission element.

Further, refractive index distribution of the optical transmission element was measured using an interference microscope. As a result, the optical transmission element had a refractive index distribution as shown in FIG. 8, and had a smooth distribution as compared with Example 3. It was found to be the refractive index of the central portion nD=1.541 and the refractive index of the outermost periphery nD=1.492.

### INDUSTRIAL APPLICABILITY

The production method of a graded index type optical transmission element according to the invention is a method useful for producing optical transmission elements that play a role of various optical transmission passages in a light focusing optical fiber, a light focusing rod lens, a light sensor and the like, or optical transmission element used in arrays for image transmission.

1. A method of producing a graded index type optical transmission element having a layer having different refractive indexes from the center toward the outer periphery, characterized in that a cylindrical transparent resin is used as a core wire, a monomer having a refractive index after polymerization different from a refractive index of the core wire, or a mixture of the monomer and a polymer, is adhered to the outer periphery of the core wire, the resulting adhered product is allowed to stand for a predetermined time to diffuse the monomer inside the core wire from the outer periphery of the core wire toward the central portion thereof at an appropriate concentration distribution, and the monomer adhered and diffused is polymerized to cure.

2. The method of producing a graded index type optical transmission element according to claim 1, which produces an optical transmission element comprising n+2 layers by further adhering a monomer or a mixture of the monomer and a polymer to the outer periphery of the optical transmission element obtained by the method, allowing the resulting adhered product to stand for a predetermined time to thereby diffuse the monomer inside the optical transmission element from the outer periphery thereof toward the central portion thereof at an appropriate concentration distribution, polymerizing the monomer adhered and diffused to cure, and repeating the above steps one to n times.

3. The method of producing a graded index type optical transmission element according to claim 2, characterized in that the monomer or a mixture of the monomer and a polymer, corresponding to the respective layer is used such that the refractive index of the inner layer is higher than the refractive index of the outer layer.

4. The method of producing a graded index type optical transmission element according to claim 1, characterized in that the monomer or a mixture of the monomer and a polymer is used such that each layer has a thickness of 100 μm or less.

5. The method of producing a graded index type optical transmission element according to claim 1, characterized in that the adhesion is conducted at a free interfacial portion of a liquid level of the monomer or the mixture of the monomer and a polymer by passing the core wire so as to pull up the same in the monomer or the mixture of the monomer and a polymer from the lower side to the upper side.

6. The method of producing a graded index type optical transmission element according to claim 1, characterized in that the adhesion is conducted while rotating the monomer or the mixture of the monomer and a polymer in horizontal direction.

7. The method of producing a graded index type optical transmission element according to claim 1, characterized in that time that the adhered product is allowed to stand for diffusion is 60 seconds.

8. The method of producing a graded index type optical transmission element according to claim 2, characterized in that the monomer or a mixture of the monomer and a polymer is used such that each layer has a thickness of 100 μm or less.

9. The method of producing a graded index type optical transmission element according to claim 3, characterized in that the monomer or a mixture of the monomer and a polymer is used such that each layer has a thickness of 100 μm or less.

10. The method of producing a graded index type optical transmission element according to claim 2, characterized in that the adhesion is conducted at a free interfacial portion of a liquid level of the monomer or the mixture of the monomer and a polymer by passing the core wire so as to pull up the same in the monomer or the mixture of the monomer and a polymer from the lower side to the upper side.

11. The method of producing a graded index type optical transmission element according to claim 3, characterized in that the adhesion is conducted at a free interfacial portion of a liquid level of the monomer or the mixture of the monomer and a polymer by passing the core wire so as to pull up the same in the monomer or the mixture of the monomer and a polymer from the lower side to the upper side.

12. The method of producing a graded index type optical transmission element according to claim 2, characterized in that the adhesion is conducted while rotating the monomer or the mixture of the monomer and a polymer in horizontal direction.

13. The method of producing a graded index type optical transmission element according to claim 3, characterized in that the adhesion is conducted while rotating the monomer or the mixture of the monomer and a polymer in horizontal direction.

14. The method of producing a graded index type optical transmission element according to claim 2, characterized in that time that the adhered product is allowed to stand for diffusion is 60 seconds.
